(19) United States
(12) Patent Application Publication
(10) Pub. No.: US 2024/0179286 A1
(43) Pub. Date: May 30, 2024

(54) SYSTEMS AND METHODS OF NEAR EYE IMAGING PRODUCT VIRTUAL IMAGE DISTANCE MAPPING

(71) Applicant: Meta Platforms Technologies, LLC, Menlo Park, CA (US)

(72) Inventors: Ye Yin, Pleasanton, CA (US); San-Ching De La Cruz, Santa Clara, CA (US)

(21) Appl. No.: 18/509,947

(22) Filed: Nov. 15, 2023

Related U.S. Application Data
(60) Provisional application No. 63/385,269, filed on Nov. 29, 2022.

(51) Int. Cl. H04N 13/15; H04N 13/207; H04N 13/296; H04N 13/344; H04N 23/957

(52) U.S. Cl. CPC H04N 13/15; H04N 13/207; H04N 13/296; H04N 13/344; H04N 23/957

(57) ABSTRACT

A computer-implemented method may include receiving, by at least one processor, imaging results produced in one shot with a microlens array. The method additionally may include generating, by the at least one processor, virtual image distance maps for two or more colors based on the imaging results. The method also may include storing, by the at least one processor, the virtual image distance maps in a memory accessible to the at least one processor. The method further may include projecting images, by the at least one processor, based on the virtual image distance maps. Various other methods, systems, and computer-readable media are also disclosed.

### CROSS REFERENCE TO RELATED APPLICATION

This application claims the benefit of priority under 35 U.S.C. § 119(e) of U.S. Provisional Application No. 63/385,269, filed Nov. 29, 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method of near eye imaging product virtual image distance mapping.

FIG. 2 is a graphical illustration depicting virtual image distance definition in a virtual reality headset.

FIG. 3 is a graphical illustration depicting a traditional method used to characterize virtual image distance.

FIG. 4 is graphical illustration depicting virtual image distance values.

FIG. 5 is a graphical illustration depicting characteristics of a light field camera versus a traditional camera.

FIG. 6 is a graphical illustration depicting lens occlusion.

FIG. 7 is a graphical illustration depicting an imaging component depth map.

FIG. 8 is a graphical illustration depicting a virtual reality headset.

FIG. 9 is a graphical illustration depicting virtual image distance maps for different colors.

FIG. 10 is an illustration of example augmented-reality glasses that may be used in connection with embodiments of this disclosure.

FIG. 11 is an illustration of an example virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

For virtual imaging, a virtual imaging distance (VID) value characterizes the virtual reality headset or any other near-to-eye display associated with one or more magnification lens which projects the overall image to certain viewing distances. The traditional method involves engaging motorized method and scanning the lens from near to far, which is time consuming and merely obtains one point of virtual imaging distance value.

Features from any of the embodiments described herein may be used in combination with one another in accordance with the general principles described herein. These and other embodiments, features, and advantages will be more fully understood upon reading the following detailed description in conjunction with the accompanying drawings and claims.

The present disclosure is generally directed to near eye imaging product virtual image distance mapping. As will be explained in greater detail below, embodiments of the present disclosure may receive imaging results produced in one shot with a microlens array, generate virtual image distance maps for two or more colors based on the imaging results, store the virtual image distance maps in a memory accessible to the at least one processor, and project images based on the virtual image distance maps.

Features from any of the embodiments described herein may be used in combination with one another in accordance with the general principles described herein. These and other embodiments, features, and advantages will be more fully understood upon reading the following detailed description in conjunction with the accompanying drawings and claims.

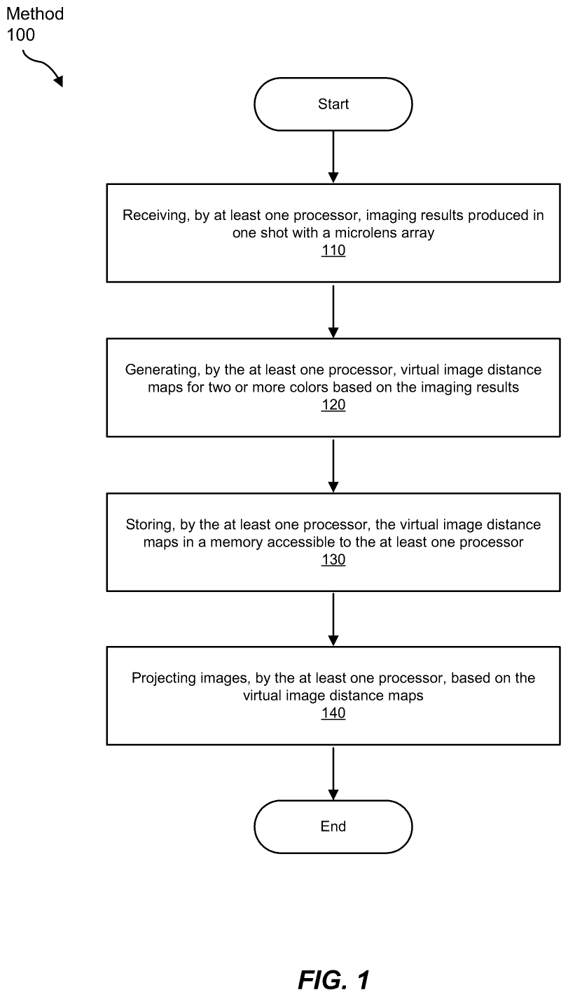

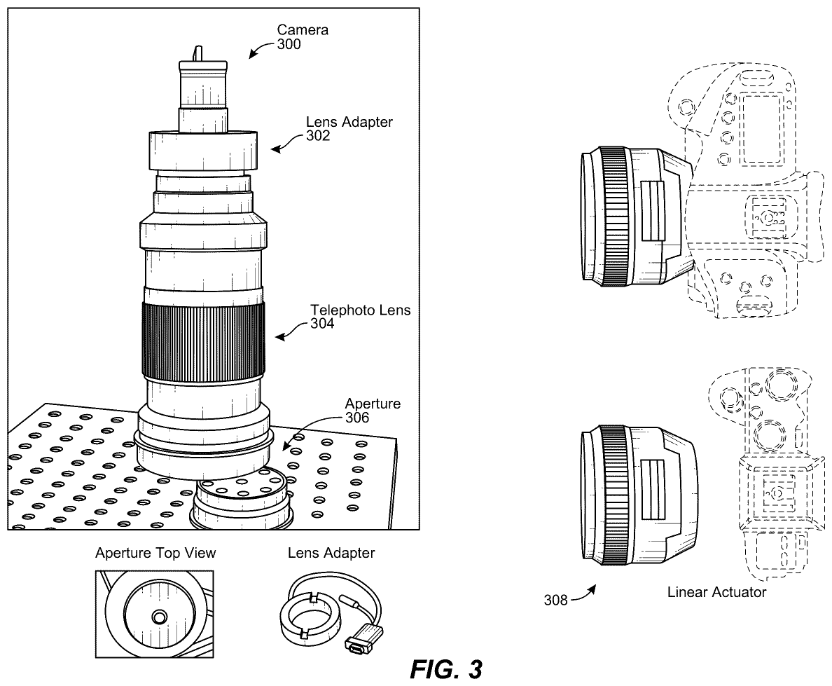

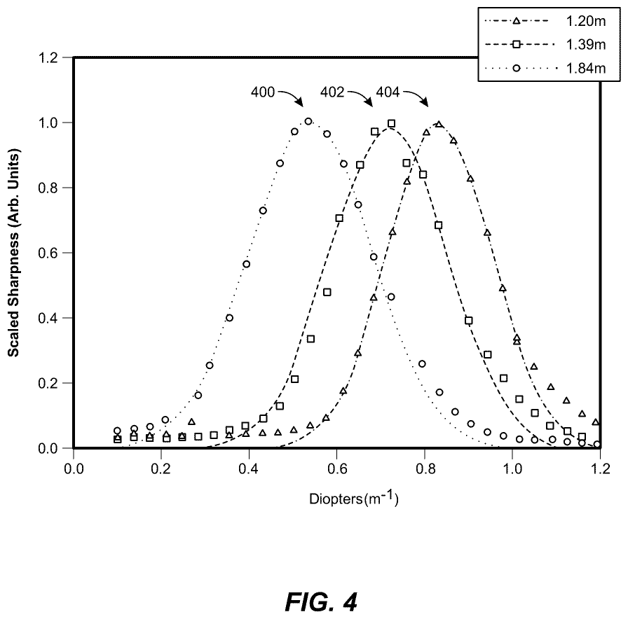

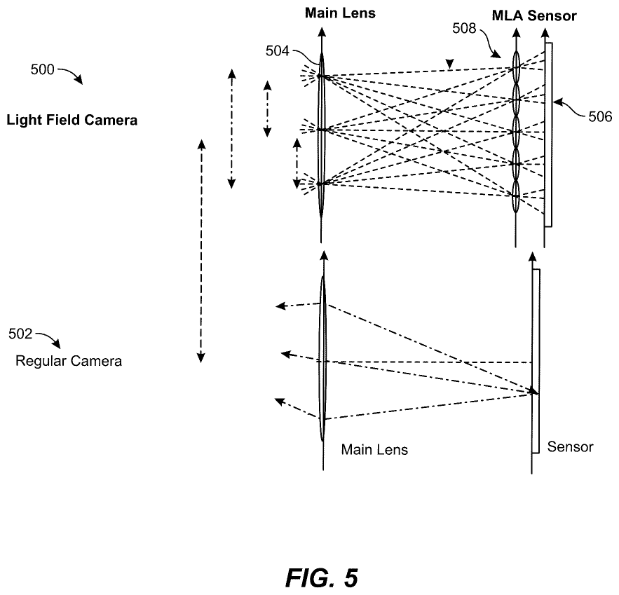

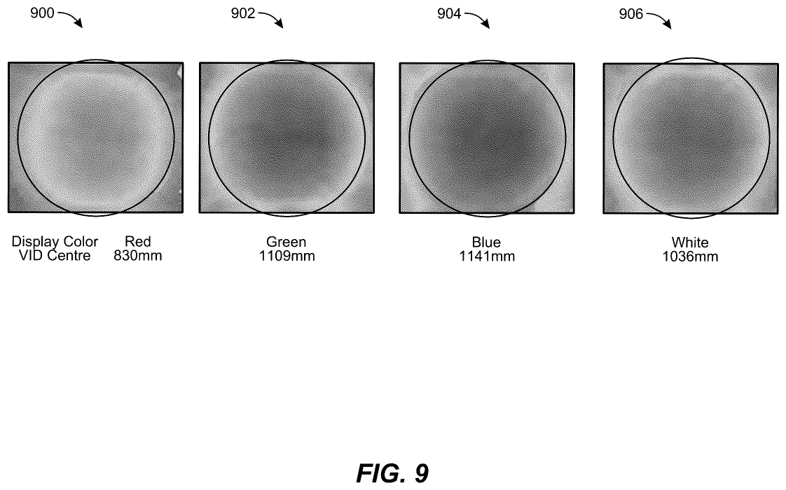

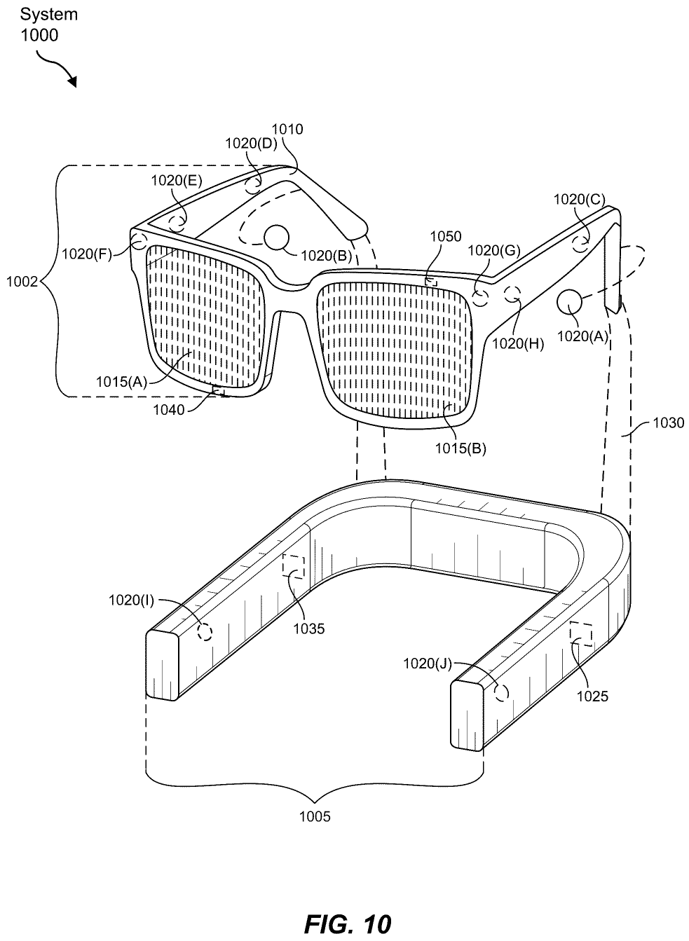

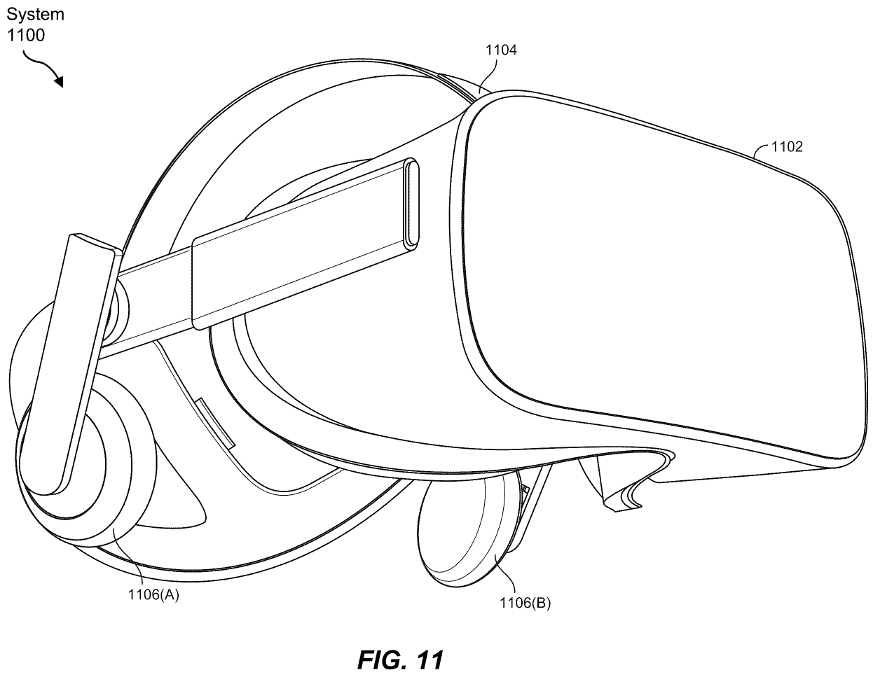

The following will provide, with reference to FIGS. 1-8, detailed descriptions of near eye imaging product virtual image distance mapping. For example, methods of near eye imaging product virtual image distance mapping will be described with reference to FIG. 1. Additionally, virtual image distance definition in a virtual reality headset will be described with references to FIGS. 3 and 4. Also, imaging equipment will be described below with reference to FIGS. 5-8. Further, virtual image distance maps for different colors will be described below with reference to FIG. 9. Further, artificial reality applications will be described below with reference to FIGS. 10 and 11.

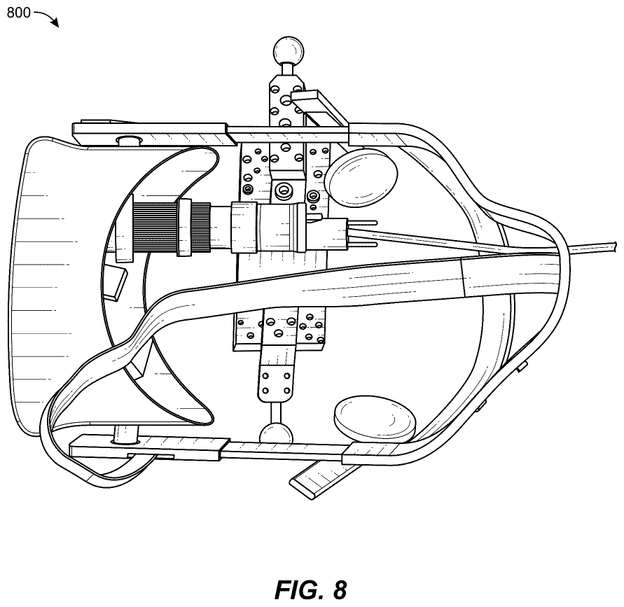

FIG. 1 is a flow diagram of an exemplary computer-implemented method 100 for near eye imaging product virtual image distance mapping. The steps shown in FIG. 1 may be performed by any suitable computer-executable code and/or computing system, including the system(s) illustrated in FIGS. 8, 10, and 11. In one example, each of the steps shown in FIG. 1 may represent an algorithm whose structure includes and/or is represented by multiple sub-steps, examples of which will be provided in greater detail below.

As illustrated in FIG. 1, at step 110 one or more of the systems described herein may receive imaging results. For example, at least one processor may receive imaging results produced in one shot with a microlens array.

At step 120, one or more of the systems described herein may generate virtual image distance maps. For example, at least one processor may generate virtual image distance maps for two or more colors based on the imaging results.

At step 130, one or more of the systems described herein may store the virtual image distance maps. For example, at least one processor may store the virtual image distance maps in a memory accessible to the at least one processor.

At step 140, one or more of the systems described herein may project images. For example, at least one processor may project images based on the virtual image distance maps.

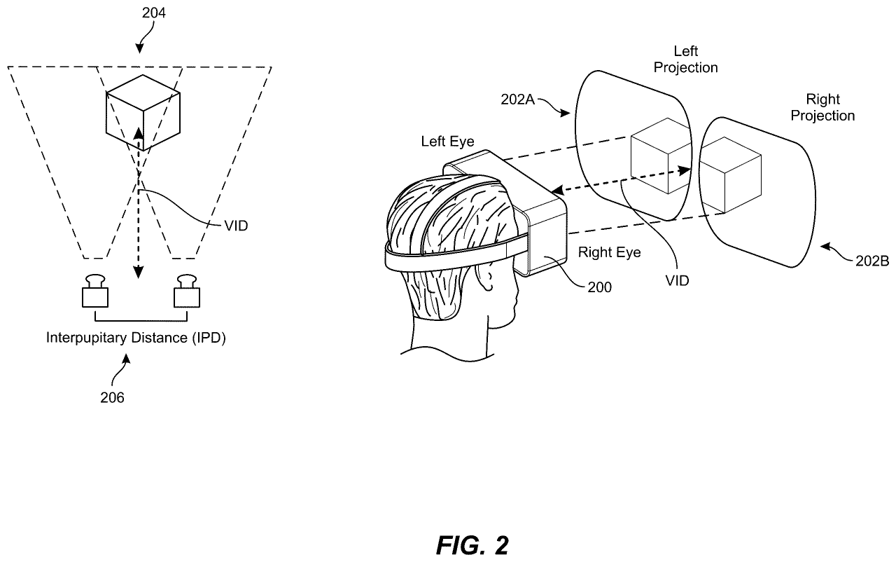

FIG. 2 depicts VID definition in a virtual reality headset 200. Left and right projections 202A and 202B must be projected at a particular VID for a resulting virtual image 204 of an object to appear, for a user's interpupillary distance 206, in a manner that provides a proper virtual experience for the user.

FIG. 3 depicts a traditional technique used to characterize virtual image distance. Utilizing one or more motorized adaptors between lens and camera is a typical solution for determining VID. FIG. 3 shows typical components used to determine VID in this manner, including camera 300, lens adapter 302, lens 304, aperture 306, and linear actuator 308. This typical technique is slow and has limited on-axis capability. Also, any off-axis VID value requires use of a camera array, which adds complexity and inaccuracies.

VID is a key metric for virtual reality (VR) products. Typically, larger VID capabilities aid in mimicking a real perception experience. However, if the display resolution pixels per inch (PPI) is not high enough or if pixel fill factor is low, the Mosaic (e.g., windows grid effects) will appear.

FIG. 4 depicts virtual image distance values. Traditionally, the VID is measured by mechanically scanning through different focal lengths so that the peak value can show up with clear line pair resolution modulation transfer function (MTF) analysis. FIG. 4 shows how the VID looks like at different color channels 400-404. However, this technique has limitations. For example, the technique is slow, with a cycle time required to get one full set of VID values being about 30 motor movements and 100 seconds. Also, only an on-axis VID value is obtained using this technique. In contrast, the systems and methods disclosed herein utilize a microlens array assisted light field camera to measure the VID map.

FIG. 5 depicts characteristics of a light field camera 500 versus a traditional camera 502. The light field camera 500 forms an image in the micro lens array 504 and then re-projects the image to a sensor 506. The microlens array 504 typically collects light from multiple pupil entrances with different pupils 508. The final sensor 506 receives light from multiple forecasted distances.

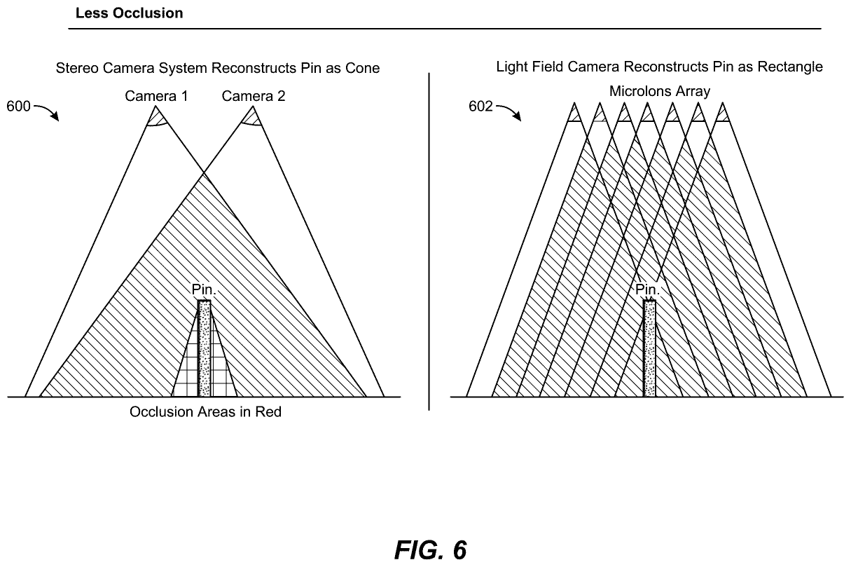

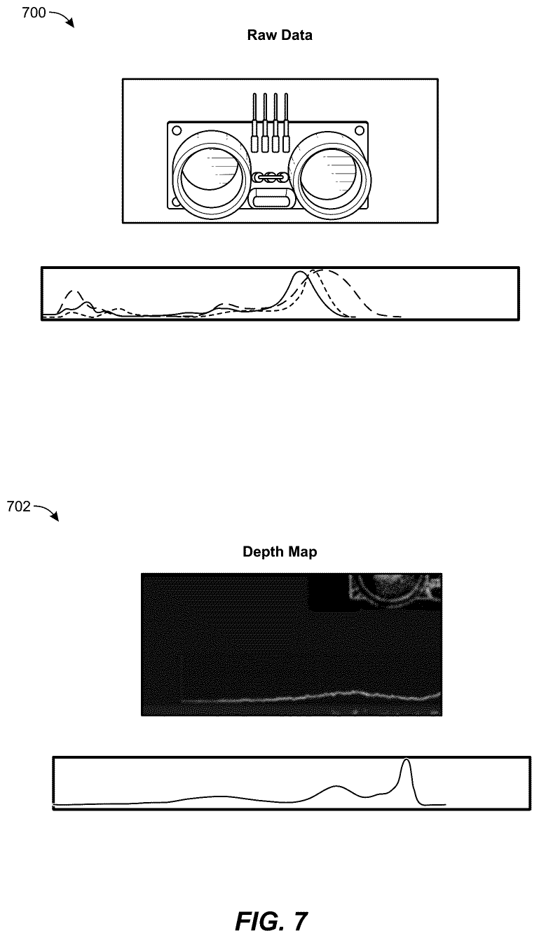

FIG. 6 depicts lens occlusion for a stereo camera 600, and lack thereof for a light field camera 602. A benefit of the lens-array method is that it completely avoids the occlusion effect. These differences are demonstrated in FIG. 7 in the form of raw data 700 of a component and a depth map 702 of a headset 800 depicted in FIG. 8.

FIG. 9 depicts virtual image distance maps for different colors (e.g., a red channel 900, a green channel 902, a blue channel 904, and/or a white channel 906. Using the microlens array assisted light field approach, the VID maps for different color channels can be measured simultaneously (e.g., in one shot).

As set forth above, the present disclosure has detailed a concept/apparatus/data of VID map acquisition capability using a microlens array assisted light field approach. The disclosed systems and methods have a one-shot-super-fast speed, collecting much more VID map data than is possible using a single point. The disclosed systems and methods also benefit from a small/easy setup.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

### EXAMPLE EMBODIMENTS

Example 1: A computer-implemented method may include receiving, by at least one processor, imaging results produced in one shot with a microlens array, generating, by the at least one processor, virtual image distance maps for two or more colors based on the imaging results, storing, by the at least one processor, the virtual image distance maps in a memory accessible to the at least one processor, and projecting images, by the at least one processor, based on the virtual image distance maps.

Example 2: The computer-implemented method of Example 1, wherein the images include left and right images projected at a particular virtual imaging distance.

Example 3: The computer-implemented method of any of Examples 1 and 2, wherein the imaging results are received from a microlens array assisted light field camera.

Example 4: The computer-implemented method of any of Examples 1-3, wherein the light field camera forms an image in the microlens array and then re-projects the image to a sensor.

Example 5: The computer-implemented method of any of Examples 1-4, wherein the microlens array collects light from multiple pupil entrances with different pupils and the sensor receives the light from multiple forecasted distances.

Example 6: The computer-implemented method of any of Examples 1-5, wherein the light field camera avoids a lens occlusion effect.

Example 7: The computer-implemented method of any of Examples 1-6, wherein the virtual image distance maps include a plurality of simultaneously measured virtual image distance maps for a plurality of different color channels.

Example 8: A system may include at least one physical processor and physical memory comprising computer-executable instructions that, when executed by the physical processor, cause the physical processor to receive imaging results produced in one shot with a microlens array, generate virtual image distance maps for two or more colors based on the imaging results; store the virtual image distance maps in a memory accessible to the physical processor, and project images based on the virtual image distance maps.

Example 9: The system of Example 8, wherein the images include left and right images projected at a particular virtual imaging distance.

Example 10: The system of Examples 8 or 9, wherein the imaging results are received from a microlens array assisted light field camera.

Example 11: The system of any of Examples 8-10, wherein the light field camera forms an image in the microlens array and then re-projects the image to a sensor.

Example 12: The system of any of Examples 8-11, wherein the microlens array collects light from multiple pupil entrances with different pupils and the sensor receives the light from multiple forecasted distances.

Example 13: The system of any of Examples 8-12, wherein the light field camera avoids a lens occlusion effect.

Example 14: The system of any of Examples 8-13, wherein the virtual image distance maps include a plurality of simultaneously measured virtual image distance maps for a plurality of different color channels.

Example 15: A non-transitory computer-readable medium may include one or more computer-executable instructions that, when executed by at least one processor of a computing device, cause the computing device to receive imaging results produced in one shot with a microlens array, generate virtual image distance maps for two or more colors based on the imaging results, store the virtual image distance maps in a memory accessible to the computing device, and project images based on the virtual image distance maps.

Example 16: The non-transitory computer-readable medium of Example 15, wherein the images include left and right images projected at a particular virtual imaging distance.

Example 17: The non-transitory computer-readable medium of Examples 15 or 16, wherein the imaging results are received from a microlens array assisted light field camera.

Example 18: The non-transitory computer-readable medium of any of Examples 15-17, wherein the light field camera forms an image in the microlens array and then re-projects the image to a sensor.

Example 19: The non-transitory computer-readable medium of any of Examples 15-18, wherein the microlens array collects light from multiple pupil entrances with different pupils and the sensor receives the light from multiple forecasted distances.

Example 20: The non-transitory computer-readable medium of any of Examples 15-19, wherein the virtual image distance maps include a plurality of simultaneously measured virtual image distance maps for a plurality of different color channels.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive sensed image data to be transformed, transform the sensed image data, output a result of the transformation to calibrate an imaging device, use the result of the transformation to calibrate an imaging device, and store the result of the transformation to calibrate an imaging device. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by at least one processor, imaging results produced in one shot with a microlens array;
generating, by the at least one processor, virtual image distance maps for two or more colors based on the imaging results;
storing, by the at least one processor, the virtual image distance maps in a memory accessible to the at least one processor; and
projecting images, by the at least one processor, based on the virtual image distance maps.

2. The computer-implemented method of claim 1, wherein the images include left and right images projected at a particular virtual imaging distance.

3. The computer-implemented method of claim 1, wherein the imaging results are received from a microlens array assisted light field camera.

4. The computer-implemented method of claim 3, wherein the light field camera forms an image in the microlens array and then re-projects the image to a sensor.

5. The computer-implemented method of claim 4, wherein the microlens array collects light from multiple pupil entrances with different pupils and the sensor receives the light from multiple forecasted distances.

6. The computer-implemented method of claim 3, wherein the light field camera avoids a lens occlusion effect.

7. The computer-implemented method of claim 1, wherein the virtual image distance maps include a plurality of simultaneously measured virtual image distance maps for a plurality of different color channels.

8. A system comprising:
at least one physical processor; and
physical memory comprising computer-executable instructions that, when executed by the physical processor, cause the physical processor to:
receive imaging results produced in one shot with a microlens array;
generate virtual image distance maps for two or more colors based on the imaging results;
store the virtual image distance maps in a memory accessible to the physical processor; and
project images based on the virtual image distance maps.

9. The system of claim 8, wherein the images include left and right images projected at a particular virtual imaging distance.

10. The system of claim 8, wherein the imaging results are received from a microlens array assisted light field camera.

11. The system of claim 10, wherein the light field camera forms an image in the microlens array and then re-projects the image to a sensor.

12. The system of claim 11, wherein the microlens array collects light from multiple pupil entrances with different pupils and the sensor receives the light from multiple forecasted distances.

13. The system of claim 10, wherein the light field camera avoids a lens occlusion effect.

14. The system of claim 8, wherein the virtual image distance maps include a plurality of simultaneously measured virtual image distance maps for a plurality of different color channels.

15. A non-transitory computer-readable medium comprising one or more computer-executable instructions that, when executed by at least one processor of a computing device, cause the computing device to:
receive imaging results produced in one shot with a microlens array;
generate virtual image distance maps for two or more colors based on the imaging results;
store the virtual image distance maps in a memory accessible to the computing device; and
project images based on the virtual image distance maps.

16. The non-transitory computer-readable medium of claim 15, wherein the images include left and right images projected at a particular virtual imaging distance.

17. The non-transitory computer-readable medium of claim 15, wherein the imaging results are received from a microlens array assisted light field camera.

18. The non-transitory computer-readable medium of claim 17, wherein the light field camera forms an image in the microlens array and then re-projects the image to a sensor.

19. The non-transitory computer-readable medium of claim 18, wherein the microlens array collects light from multiple pupil entrances with different pupils and the sensor receives the light from multiple forecasted distances.

20. The non-transitory computer-readable medium of claim 15, wherein the virtual image distance maps include a plurality of simultaneously measured virtual image distance maps for a plurality of different color channels.
